(19) United States
(12) Patent Application Publication
(10) Pub. No.: US 2008/0292170 A1
(43) Pub. Date: Nov. 27, 2008

(54) Method for scattered radiation correction in an X-ray computed tomography system, and method for generating a tomographic display corrected for scattered radiation, and/or an X-ray computed tomography system

(76) Inventors: Herbert Bruder, Hochstadt (DE); Arkadiusz Polacin, Uttenreuth (DE); Rainer Raupach, Heroldsbach (DE); Karl Stierstorfer, Erlangen (DE)

Correspondence Address: HARNESS, DICKEY & PIERCE, P.L.C., P.O.BOX 8910, RESTON, VA, 20195, US

(21) Appl. No.: 12/153,120

(22) Filed: May 14, 2008

(30) Foreign Application Priority Data
May 15, 2007 (DE) 10 2007 022 714.2

(51) Int. Cl. G06K 9/00

(52) U.S. Cl. 382/131

(57) ABSTRACT

A method is disclosed for scattered radiation correction in an X-ray computed tomography system having at least two tube-detector systems. It is provided, according to at least one embodiment, to make use of a data record that includes data projections required for the reconstruction and a prescribed number of first scattered radiation projections. Respective scattered radiation components for the scattered radiation correction of all data projections are determined on the basis of the first scattered radiation projections and second scattered radiation projections determined therefrom.

### PRIORITY STATEMENT

The present application hereby claims priority under 35 U.S.C. §119 on German patent application number DE 10 2007 022 714.2 filed May 15, 2007, the entire contents of which is hereby incorporated herein by reference.

### FIELD

Embodiments of the invention generally relate to a method for scattered radiation correction in an X-ray computed tomography system, a method for generating a tomographic display, corrected for scattered radiation, of an examination object by way of an X-ray computed tomography system, and/or an X-ray computed tomography system.

### BACKGROUND

An X-ray computed tomography system having a number of tube-detector systems that are rotated in common about a system axis in order to record a data record suitable for the reconstruction of a tomographic display is known, for example, from DE 103 025 65. In such an X-ray computed tomography system, the problem arises during the recording of the data record that a scattered radiation caused by one of the tube-detector systems is also detected by the other tube-detector system. Without a scattered radiation correction, this leads to a substantial impairment of the quality of the tomographic display.

It is known to use model-based approaches for the scattered radiation correction. In this case, the scattered radiation caused by one tube-detector system in the respective other tube-detector system is determined on the basis of model-based approaches in a fashion starting from a model of an examination object as, for example, in US 2005078787 A1. It is disadvantageous here that actual scattering conditions cannot be satisfactorily described by the model-based approaches. That reduces the accuracy of the scattered radiation correction carried out in this way and leads to a reduction in quality in the tomographic displays.

It is known from EP 1502548 A1 to determine the scattered radiation firstly on a prescribed phantom and to use the scattered radiation thus determined for the scattered radiation correction of a data record that is recorded for the reconstruction of an examination object different from the phantom. This is complicated and time-intensive.

Model-based approaches and prior scattered radiation measurements on phantoms are complicated and not particularly exact, especially taking account of the fact that substantial deviations can occur with regard to the scattered radiation in the case of examination objects of the same generic type.

The scattered radiation can also be determined directly on the examination object in a scattered radiation measurement prior to the recording of the data record. This leads to extended recording times for the data record, and to an increased radiation burden for the examination object.

### SUMMARY

In at least one embodiment of the invention, a method for scattered radiation correction in an X-ray computed tomography system is specified, having at least two tube-detector systems that enables a particularly simple and yet accurate determination of a scattered radiation component. It is further intended, in at least one embodiment, to specify such a method that can be carried out particularly effectively in terms of time, and causes essentially no additional radiation burden for an examination object. A further aim of at least one embodiment is to specify a method for generating a tomographic display corrected for scattered radiation with the aid of which the same advantages can be achieved as in the case of the abovementioned method. Moreover, it is intended, in at least one embodiment, to specify an X-ray computed tomography system suitable for carrying out the methods.

According to a first aspect of an embodiment of the invention, a method is provided for scattered radiation correction in an X-ray computed tomography system. The X-ray computed tomography system has at least two tube-detector systems that are rotated about a system axis of the X-ray computed tomography system in order to record a data record for reconstructing an examination object.

According to at least one embodiment of the invention, the data record is assembled from a multiplicity of data projections and a prescribed number of first scattered radiation projections. In the scope of this at least one embodiment of the invention, it is understood here as regards a data projection that in order to record it at least two tubes, and detectors assigned to them, of the tube-detector systems are simultaneously active, and that an X-radiation emanating from the respective tube is detected by the assigned detector after having penetrated the examination object. According to at least one embodiment of the invention, a scattered radiation projection is understood to mean that the at least one detector of a tube-detector system detects a scattered radiation caused by the other tube-detector system or systems, while the tube assigned to the detector emits no X-radiation. In this context, the term “scattered radiation projection” can be understood as imaging in the case of which there is “projected” onto the at least one detector of the tube-detector system with inactive tube the scattered radiation caused by the other tube-detector systems.

The data projections are recorded during simultaneous operation of at least two of the number of tube-detector systems. Thus, a number of data projections for different projection angles are recorded simultaneously. Consequently, by contrast with an X-ray computed tomography system, using only one tube-detector system, the time period for recording the data record can be reduced, and the temporal resolution can be improved.

Apart from the data projections, the data record further has the first scattered radiation projections. The data record can be recorded by, for example, detecting one or more first scattered radiation projection(s) between a number of consecutive data projections. Since a scattered radiation component included in the data projections does not change substantially as a rule for consecutive data projections, the scattered radiation projections can be recorded in a raster that is coarse by comparison with the data projections. Consequently, on the one hand a maximum number of data projections required for the reconstruction of the tomographic display can be recorded, and on the other hand a sufficient number of first scattered radiation projections can be recorded for a scattered radiation correction of the data projections that is as exact as possible.

Provided that no data projection can be recorded as a consequence of the recording of a first scattered radiation projection for a projection direction, the data projection can be determined in a manner known per se from existing data projections, for example by way of interpolation. Provided that a number of redundant data projections can be recorded for a projection direction, there is no mandatory requirement for interpolation of missing data projections. The missing data projections can simply be omitted in the reconstruction with the aid of a normalization for the redundant data projections that is adapted to the redundancy. The reconstruction result is not substantially impaired in this case. Thus, it is possible to record the first scattered radiation projections at projection angles at which the redundant data projections would be detected in any case without having to expect substantial losses in quality.

The scattered radiation projections locally reflect the actual scattered radiation component. Starting therefrom, a scattered radiation correction is performed for a data projection that is adjacent to a scattered radiation projection on the basis of the scattered radiation component determined from the respective scattered radiation projection. Here, the term “adjacent” can relate both to the azimuthal direction with reference to the system axis, that is to say in or counter to the rotary movement of the tube-detector systems, and to the direction parallel to the system axis, for example in or counter to a movement direction of the examination object during the recording of the data record.

For the remaining data projections not corrected by way of the first scattered radiation projections, second scattered radiation projections respectively assigned to the remaining data projections are determined from the first scattered radiation projections. The remaining data projections are corrected for scattered radiation with the aid of the second scattered radiation projections.

It is made plain from the above statements that at least one embodiment of the inventive method can be carried out in a fashion that is particularly simple and effective in terms of time. There is no need for prior recordings for detecting the scattered radiation by using a phantom or directly on the examination object. By contrast with a method in which the scattered radiation components are determined directly on the examination object, the radiation burden on the examination object can be substantially reduced. Furthermore, in accordance with at least one embodiment of the inventive method the scattered radiation correction is not based exclusively on model-based approaches, but on actually measured scattered radiation components. This enables a scattered radiation correction that is particularly well adapted to the respective actual scattering conditions.

In order to determine the second scattered radiation projections from the first scattered radiation projections, it is possible to make use of essentially any desired mathematical methods, in particular approximation methods. The second scattered radiation projections are preferably determined from the first scattered radiation projections by way of interpolation of extrapolation. This can be carried out particularly effectively with regard to'computing time.

The first scattered radiation projections can be recorded at permanently prescribed azimuthal angle positions with reference to the system axis. Such a mode of procedure can be converted into a scanning protocol in a particularly simple way. For example, the first scattered radiation projections can be recorded with a prescribed azimuthal angle spacing, for example of 15°. However, it is also possible for the respective azimuthal angle positions at which the first scattered radiation projections are recorded to be determined on the basis of an evaluation, performed essentially in real time, of one or more data projections. In order to determine the azimuthal angle positions, it is also possible, if appropriate in a supplementary fashion, to make use of information relating to the course of the scanning. Such information can be determined, for example, from a recording protocol, also known as a scanning protocol, used for recording the data projections.

Moreover, if appropriate in a supplementary fashion, the number and/or azimuthal angle spacing of the azimuthal angle positions can be selected as a function of a geometric cross-sectional shape of the examination object perpendicular to the system axis. It is possible in this case that the first scattered radiation projections lie more densely in certain azimuthal angle ranges than in others. The cross-sectional shape can be taken into account during the examination of a human body, for example. In the case of the human body, the cross-sectional shape in the thorax region resembles an elliptical shape, while the head region is more reminiscent of a circular shape. Given a suitable selection of the azimuthal angle positions for the first scattered radiation projections, the scattered radiation components can be determined with particular accuracy, and this has a particularly advantageous effect on the quality of the tomographic displays determined from the data projections corrected to scattered radiation.

In order to record the first scattered radiation projections, one tube of one of the tube-detector systems can successively be respectively deactivated. The detector, assigned to the deactivated tube, of the respective tube-detector system can be used to determine the scattered radiation component, caused by the tube(s) of the further tube-detector system(s), from the respective first scattered radiation projection. Provided that more than two tube-detector systems are present, preferably only one tube of one of the tube-detector systems is deactivated. This enables a particularly simple determination of the scattered radiation component, caused by the other tube-detector systems, for the detector assigned to the deactivated tube.

At least one embodiment of the inventive method is equally suitable for sequential circular scanning and spiral scanning of the examination object.

According to a second aspect of at least one embodiment of the invention, a method is provided for generating a tomographic display, corrected for scattered radiation, of an examination object with the aid of an X-ray computed tomography system having at least two tube-detector systems. The at least two tube-detector systems are provided for recording a data record for reconstructing an examination object, and in this case are rotated about a system axis of the X-ray computed tomography system. The recorded data record is assembled from a multiplicity of data projections and a prescribed number of first scattered radiation projections. The method comprises the following steps:
a) recording the data record by means of a single scan of the examination object, at least one first scattered radiation projection respectively being recorded between a number of consecutive data projections recorded during simultaneous operation of the at least two tube-detector systems, at least one tube of a tube-detector system respectively being deactivated with regard to the emitting of X-radiation during the recording of the first scattered radiation projection,
b) carrying out a scattered radiation correction during the data projections of the data record as claimed in accordance with the inventive method for scattered radiation correction, or in accordance with a refinement of this method, and
c) generating the tomographic display by using the data projections corrected for scattered radiation, obtained from step b).

The method for producing a tomographic display, corrected for scattered radiation, of an examination object includes at least one embodiment of the inventive method for scattered radiation correction, or a refinement of the same. To this extent, reference may be made to the above statements as regards the advantages and advantageous effects.

According to a third aspect of at least one embodiment of the invention, there is provided an X-ray computed tomography system comprising at least two tube-detector systems that can be rotated about a system axis of the X-ray computed tomography system in order to record a data record for reconstructing an examination object. Furthermore, the X-ray computed tomography system has a scattered radiation correction unit designed to carry out the inventive method for scattered radiation correction, or a refinement of the same.

According to a fourth aspect of at least one embodiment of the present invention, there is provided an X-ray computed tomography system comprising an operating and imaging unit designed to carry out at least one embodiment of an inventive method for generating a tomographic display of an examination object.

Reference may be made to the statements relating to at least one embodiment of the respective inventive method for advantages and advantageous effects of the X-ray computed tomography systems according to the third and fourth aspects, which are applied analogously.

### BRIEF DESCRIPTION OF THE DRAWINGS

Example embodiments of the invention are explained in more detail below with the aid of figures, in which:

FIG. 1 shows an embodiment of an inventive X-ray computed tomography system;

FIG. 2 shows a section view of the X-ray computed tomography system of FIG. 1;

FIG. 3 shows an operating plan of the X-ray computed tomography system illustrated in FIG. 1; and

FIG. 4 shows a flowchart of an embodiment of the inventive method for generating a tomographic display corrected for scattered radiation.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention. Identical or functionally identical elements are denoted in the figures throughout by the same reference symbols. The illustrations in the figures are not true to scale, and scales can vary between the figures. The X-ray computed tomography system is described below in this mode of operation only to the extent that is necessary to understand embodiments of the invention.

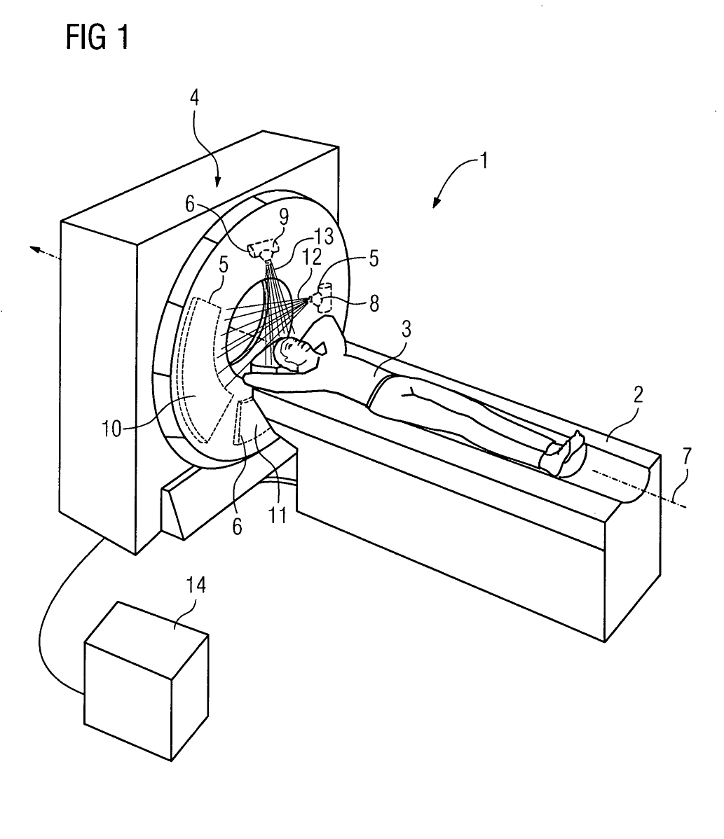

FIG. 1 shows an embodiment of an inventive X-ray computed tomography system 1. The X-ray computed tomography system 1 has a patient support table 2 with a patient's body 3 provided thereon for examination. The X-ray computed tomography system 1 further has a gantry 4 with a first tube-detector system 5, and a second tube-detector system 6, both of which can be rotated about a system axis 7. The first tube-detector system 5 or the second tube-detector system 6 has a first tube 8 or second tube 9 and, arranged respectively opposite said tubes, a first detector 10 or second detector 11 for detecting a first X-radiation 12 or second X-radiation 13 emanating from the first tube 8 or the second tube 9.

The X-ray computed tomography system 1 has a computer unit 14 by which it is possible to carry out a recording of a data record for reconstructing a tomographic display, and a scattered radiation correction of data projections of the data record. The computer unit 14 can also be used to determine the tomographic display.

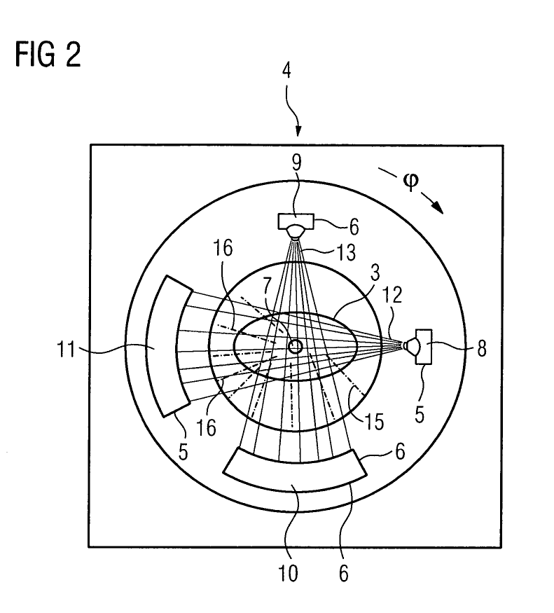

FIG. 2 shows a sectional view of the gantry 4 in a focal plane of the first tube-detector system 5 and second tube-detector system 6. The first X-radiation 12 is emitted in fan-like fashion by the first tube 8 in the direction of the patient's body 3. The first scattered radiation 15 is produced by interaction processes of the first X-radiation 12 with the patient's body 3. The first scattered radiation 15 propagates substantially in all spatial directions, that is to say also in the direction of the second detector 11 in particular.

In a similar way, the second X-radiation 13 generates a second scattered radiation 16, that propagates in the direction of the first detector 10, in particular. The two tube-detector systems 5, 6 are operated simultaneously in order to record data projections for reconstructing at least one subregion of the patient's body 3. As a result thereof, data projections recorded with the first detector 10 or the second detector 11 include a scattered radiation component caused by the second scattered radiation 13 or first scattered radiation 12. The scattered radiation components impair the quality of the tomographic display reconstructed from the data projections. For this reason, the qualitative improvement of the display requires subjecting the data projections to a scattered radiation correction.

During a scattered radiation correction, a scattered radiation component included in the data projections is removed as effectively as possible. To this end, use is made according to an embodiment of the invention of first scattered radiation projections and of second scattered radiation projections determined therefrom. The data projections and the first scattered radiation projections are recorded in a single scan of the patient's body and form the data record for an embodiment of the inventive method.

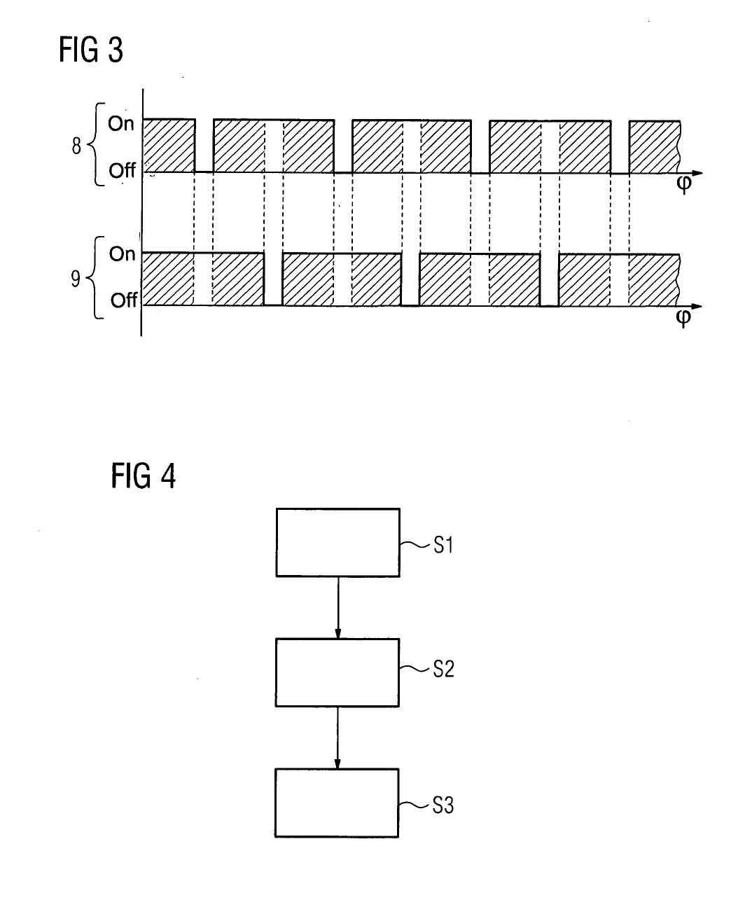

FIG. 3 shows an operating plan for the X-ray computed tomography system 1 shown in FIG. 1. More precisely, FIG. 3 shows an operating plan for recording a data record that is assembled from the data projections for reconstructing a two- or three-dimensional tomographic display of at least one subregion of the patient's body, and from the first scattered radiation projections.

Plotted in FIG. 3 is an activation state of “off” or “on” of the first tube 8 or second tube 9 as a function of an azimuthal angle φ, or projection angle. Here, the activation state “off” signifies that the first tube 8 or second tube 9 is inactive for the respective azimuthal angle range. That is to say—in essence—no first X-radiation 12 or second X-radiation 13 is emitted by the first tube 8 or second tube 9. The activation state “on” signifies that the first X-radiation 12 or second X-radiation 13 is emitted by the first tube 8 or second tube 9.

It may be remarked that the illustration in FIG. 3 is merely schematic and simplified, the point being that, for technical reasons, the transitions from the activation state “off” to “on” and from “on” to “off” are—as illustrated—capable of not taking place in accordance with a rectangular function. Further detail will not be given concerning the transitions. The transitions can be achieved by placing an absorption diaphragm upstream, by varying a tube current required for generating the first X-radiation 12 or second X-radiation 13, etc.

It is essential in this case that there exist between two “on” activation states an azimuthal angle range in which essentially no first X-radiation 12 or second X-radiation 13 is emitted by the first tube 8 or the second tube 9. “Essentially” signifies here that the emission of the first X-radiation 12 or the second X-radiation 13 is restricted at least so far that the actual scattered radiation components can be determined with sufficient accuracy with the aid of the first scattered radiation projections. A profile of the activation or deactivation of the first tube 8 or second tube 9 in accordance with the illustration of FIG. 3 is not mandatory—other profiles are entirely conceivable.

The data projections of the data record that are required for the reconstruction are recorded in those azimuthal angle ranges in which both the first tube 8 and the second tube 9 are activated. To this end, the first detector 10 and second detector 11 can be read out at corresponding projection angles. The projection angles suitable for recording data projections are marked in FIG. 3 by patching. Given suitable selection of the azimuthal angles at which the first tube 8 or second tube 9 is deactivated, it is possible for the data projections required for the reconstruction to be recorded as completely as possible. For example, given full revolution scanning of the patient's body 3 it is sufficient to detect the data projection required for the reconstruction at least in a half revolution.

Depending on the recording mode of the data record, redundant data projections are present, if appropriate, for the projection angles, and so an absence of an otherwise redundant data projection as a consequence of the recording of a first scattered radiation projection can be compensated. The redundant data can be taken into account by normalizing the redundant data during the reconstruction in a fashion adapted to the respective redundancy. The normalization can be adapted as appropriate depending on the number of missing data projections. If, as a consequence of the deactivation of the first tube 8 or second tube 9, it is impossible to record a data projection required for the reconstruction, the missing data projection can be determined from the actually recorded data projections, for example by way of interpolation.

The first scattered radiation projections are recorded in those azimuthal angle ranges in which either the first tube 8 or the second tube 9 is deactivated. In the event of a deactivated first tube 8, the second scattered radiation 16 striking the first detector 10 can be determined by way of the latter. The corresponding statement applies given an inactivated second tube 9. The first scattered radiation projections reflect the actual, local scattered radiation conditions for the respective azimuthal angles, and can be used for the scattered radiation correction of the data projections adjacent to the first scattered radiation projections.

For those data projections for which no adjacent first scattered radiation projections are available, an embodiment of the inventive method provides that second scattered radiation projections are determined from the first scattered radiation projections. This can be carried out, for example, by way of interpolation or extrapolation, or by another mathematical approximation method. This mode of procedure for determining the second scattered radiation projections is based on the finding that the scattered radiation component included in a data projection undergoes only weak changes locally. To this extent, it suffices to determine the scattered radiation components in a course raster and to approximate intermediate values from the determined scattered radiation components. Despite the use of an approximation for determining missing scattered radiation components, it is possible to achieve a sufficiently accurate scattered radiation correction.

On the basis of the first and second scattered radiation projections, respective scattered radiation components are determined that enable a scattered radiation correction of all the data projections of the data record.

FIG. 4 shows a flowchart of an embodiment of the inventive method for generating a tomographic display corrected for scattered radiation. The data record is recorded in a first step S1. In this case, both the data projections and the first scattered radiation projections are recorded in a single scan of at least the subregion of the patient's body 3. As already stated above in more detail, at least one first scattered radiation projection is respectively recorded with reference to the projection angle between a number of consecutive data projections recorded during simultaneous operation of the two tube-detector systems. Either the first tube 8 or the second tube 9 is deactivated in the case of the recording of the first scattered radiation projection. Such a mode of procedure for recording the data record can be used in an advantageous way to ensure that both data projections required for the reconstruction and the first scattered radiation projections can be recorded during a single scan, the first scattered radiation projections forming the basis of a scattered radiation correction of all the data projections.

In a second step S2, a scattered radiation correction is performed in accordance with the previously described mode of procedure by using the first scattered radiation projections and the second scattered radiation projections derived therefrom. In a third step S3, a two- or three-dimensional tomographic display of at least the subregion of the patient's body 3 is generated on the basis of the data projections corrected for scattered radiation and, if appropriate, on the basis of interpolated data projections.

By way of summary, at least one of the following advantages of at least one embodiment of the invention become clear from the previous statements:
the scattered radiation components can be determined in a simple way in a single scan, it being possible advantageously to take account of the actual scattering conditions of the patient's body as effectively as possible and therefore particularly precisely,
by contrast with the methods that make use only of model-based approaches to the scattered radiation correction, a more accurate scattered radiation correction can be achieved by using the first scattered radiation projections,
owing to the fact that the data projections and the first scattered radiation projections on whose basis a scattered radiation correction of all the data projections is carried out are recorded simultaneously in a single scan, it is possible to achieve a temporal advantage over methods in which the scattered radiation components are determined in a separate scan, and
moreover, the radiation burden for the examination object can be reduced by comparison with methods in which the scattered radiation components are determined by a prior or subsequent scan, and this is of great significance for medical applications, in particular.

In a departure from the abovementioned description, at least one embodiment of the inventive methods can also be applied in X-ray computed tomography systems that have more than two tube-detector systems. In this case, it is possible to achieve the abovementioned advantages in a similar way.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for scattered radiation correction in an X-ray computed tomography system having at least two tube-detector systems that are rotatable about a system axis of the X-ray computed tomography system to record a data record for reconstructing an examination object, the method comprising:
assembling the data record from a multiplicity of data projections and a number of first scattered radiation projections;
recording the data projections during simultaneous operation of the two tube-detector systems, and to record the first scattered radiation projections, respectively deactivating at least one tube of a tube-detector system with regard to emitting X-radiation;
correcting, in each case, at least one data projection adjacent to a first scattered radiation projection is for scattered radiation with the aid of a scattered radiation component determined from the respective first scattered radiation projection;
determining, for the remaining data projections, second scattered radiation projections respectively assigned to the latter from the first scattered radiation projections; and
correcting the rest of the data projections for scattered radiation with the aid of a scattered radiation component determined from the respectively assigned second scattered radiation projection.

2. The method as claimed in claim 1, wherein the second scattered radiation projections are determined from the first scattered radiation projections by use of an approximation method.

3. The method as claimed in claim 2, wherein use is made, for the approximation, of first scattered radiation projections that follow one another with reference to the system axis at least one of in an azimuthal fashion and in the direction of the system axis.

4. The method as claimed in claim 1, wherein the first scattered radiation projections are recorded at permanently prescribed azimuthal angle positions with reference to the system axis.

5. The method as claimed in claim 4, wherein at least one of the number and azimuthal angle spacing of the azimuthal angle positions are selected as a function of a recording protocol prescribed for recording the data projections.

6. The method as claimed in claim 1, wherein at least one of the number and azimuthal angle spacing of the azimuthal angle positions is selected as a function of a geometric cross-sectional shape of the examination object perpendicular to the system axis.

7. The method as claimed in claim 4, wherein the azimuthal angle positions are spaced apart uniformly from one another by a permanently prescribed angle of rotation.

8. The method as claimed in claim 1, wherein, in order to record the first scattered radiation projections, one tube of one of the tube-detector systems is alternatively respectively deactivated, and the respective first scattered radiation projection is recorded by way of a detector, assigned to the deactivated tube, of the tube-detector system.

9. The method as claimed in claim 1, wherein the tube-detector systems are rotated circularly or spirally about the system axis to record the data projections.

10. The method as claimed in claim 1, wherein the respective data projection with reference to at least one of a direction azimuthal to the system axis a direction parallel to the system axis, is adjacent to the respective first scattered radiation projection.

11. A method for generating a tomographic display, corrected for scattered radiation, of an examination object with the aid of an X-ray computed tomography system having at least two tube-detector systems that are rotated about a system axis of the X-ray computed tomography system to record a data record for reconstructing an examination object, the data record being assembled from a multiplicity of data projections and a prescribed number of first scattered radiation projections, the method comprising:
recording the data record by way of a single scan of the examination object, at least one first scattered radiation projection respectively being recorded between a number of consecutive data projections recorded during simultaneous operation of two tube-detector systems, at least one tube of a tube-detector system respectively being deactivated with regard to the emitting of X-radiation during the recording of the first scattered radiation projection;
carrying out a scattered radiation correction during the data projections of the data record as claimed in claim 1; and
generating the tomographic display by using the data projections corrected for scattered radiation, obtained from the carrying out of the scattered radiation correction.

12. The method as claimed in claim 11, wherein the data record includes a number of redundant data projections at least for one projection direction, and wherein the redundant data projections for the respective projection direction are taken into account in the generating with the aid of a normalization adapted to their redundancy.

13. An X-ray computed tomography system comprising:
at least two tube-detector systems, rotatable about a system axis of the X-ray computed tomography system to record a data record for reconstructing an examination object; and
a scattered radiation correction unit, designed to carry out a scattered radiation correction as claimed in claim 1.

14. An X-ray computed tomography system comprising an operating and imaging unit designed to carry out a method as claimed in claim 11.

15. The method as claimed in claim 2, wherein the approximation method is an interpolation or extrapolation.

16. The method as claimed in claim 15, wherein use is made, for the interpolation or extrapolation, of first scattered radiation projections that follow one another with reference to the system axis in at least one of an azimuthal fashion and in a direction of the system axis.
